(19) United States
(12) Patent Application Publication
(10) Pub. No.: US 2008/0092589 A1
(43) Pub. Date: Apr. 24, 2008

(54) Method for the Pre-Treatment of Air Prior to the Introduction Thereof Into a Cryogenic Air Separation Unit, and Corresponding Apparatus

(76) Inventors: Jean-Pierre Tranier, L'Hay-Les-Roses (FR); Serge Moreau, Velizy Villacoublay (FR)

Correspondence Address: AIR LIQUIDE;Intellectual Property, 2700 POST OAK BOULEVARD, SUITE 1800, HOUSTON, TX, 77056, US

(21) Appl. No.: 11/813,479

(22) PCT Filed: Jan. 6, 2006
(86) PCT No.: PCT/FR06/50005

§ 371 Date: Jul. 6, 2007

(30) Foreign Application Priority Data
Jan. 7, 2005 (FR) 0550073

(51) Int. Cl. F25J 3/04; B01D 53/14

(52) U.S. Cl. 62/640; 95/228

(57) ABSTRACT

The invention relates to a method for the pre-treatment of air prior to the introduction thereof into a cryogenic air separation unit, and to the corresponding apparatus. In a method for cooling air (4) containing CO<SUB>2 </SUB> by means of direct heat exchange with water (12), the acid-base balance of the water used is altered such that the pH thereof is greater than 7 and such that the water absorbs a substantial fraction of the CO<SUB>2 </SUB> contained in the air.

The present invention relates to a method of pretreating atmospheric air and in particular to a method of pretreating atmospheric air before cryogenic separation of said air, in particular by cryogenic distillation, to a pretreatment unit and to a separation unit that incorporates such a pretreatment unit.

It is known that the atmospheric air contains compounds that have to be removed before said air is introduced into the heat exchangers of the cold box of an air separation unit, especially the compounds carbon dioxide (CO₂) and water vapor (H₂O).

This is because, in the absence of such air pretreatment for removing its impurities, CO₂ and water, these impurities will condense and solidify as ice upon cooling the air to a cryogenic temperature, which may result in clogging problems in the equipment, especially the heat exchangers, distillation columns, etc.

At the present time, this air pretreatment is carried out in two phases downstream of the air compressor:
a) precooling of the air output by the compressor by tube-type heat exchangers and/or by a cooling tower for direct contact with the water.

In general, this precooling takes place in two steps.

In a first step, the air is cooled to a temperature close to the ambient temperature:
either by indirect heat exchange with atmospheric air (air cooling tower);
or by indirect heat exchange with cooling water in a tube-type exchanger—this cooling water is cooled by direct heat exchange (atmospheric tower) or indirect heat exchange (water cooling tower);
or by direct heat exchange with the cooling water in a packing tower—the packings in the tower may be loose or ordered and dependent on the metal (stainless steel) or plastic (polypropylene) temperature levels.

In a second, possibly optional, step, the air is cooled to a temperature substantially below the ambient temperature:
either by indirect heat exchange with a coolant (NH₃, R134a, etc.) that vaporizes in a tube-type exchanger; this coolant is then compressed and recondensed at a temperature close to the ambient temperature, before being expanded and introduced into the tube-type exchanger—this is then referred to as air refrigeration;
or by indirect heat exchange with the “cold” water in a tube-type exchanger;
or by direct heat exchange with the “cold” water in a packing tower; if, in the first step, a packing tower was chosen, a two-stage tower is then used, that is to say the two precooling steps are integrated into one and the same tower.

This “cold” water may be obtained in several ways:
either by indirect heat exchange with a coolant (NH₃, R134a, etc.) that vaporizes in a tube-type exchanger; this coolant is then compressed and recondensed at a temperature close to the ambient temperature, before being expanded and introduced into the tube-type exchanger—this is referred to as water refrigeration;
or by direct heat exchange in a packing tower with a dry decarbonated fluid coming from the cryogenic air separation unit; this fluid is usually “waste” nitrogen as it is a non-utilized byproduct of the production of oxygen from air—this tower is referred to as a water-nitrogen tower.
b) purification of the air, by adsorbing the water vapor and carbon dioxide by a TSA (temperature swing adsorption) process or by a PSA (pressure swing adsorption process).

In general, the removal of CO₂ and water vapor is carried out on several beds of adsorbents, namely a first adsorbent intended for preferentially stopping the water, for example a bed of activated alumina, and a second adsorbent bed for preferentially stopping the CO₂, for example a zeolite bed. The atmospheric air contains about 350 ppm of CO₂, which value may nevertheless be substantially higher on certain industrial sites that emit large quantities of CO₂ (up to 600 ppm of CO₂).

One object of the invention is to provide a method for pretreating air containing CO₂ by direct heat exchange with water so as to cool the air, characterized in that the acid-base equilibrium of the water used for this heat exchange is modified in such a way that the pH of the water is above 7 and in that the water absorbs a substantial fraction of the CO₂ contained in the air.

According to other optional aspects:
heat exchange by direct contact is carried out with loose or ordered packings;
the absorption of CO₂ in the water involves at least one of the following chemical equilibria:
CO₂(g) [symbol] CO₂(aq) (1) where g and aq indicate a gaseous phase or dissolved phase respectively;
CO₂(aq)+H₂O [symbol] H₂CO₃ (2);
H₂CO₃ [symbol] H⁺+HCO₃⁻ (3);
HCO₃⁻ [symbol] H⁺+CO₃²⁻ (4);
the temperature of the water is substantially below the ambient temperature and/or below the temperature of the cooling water obtained by direct exchange with the atmospheric air;
the acid-base equilibrium of the water is modified in such a way that the pH of the water is above 8;
the water contains calcium and the following equilibrium occurs during direct contact between the water and the air:
   CaCO₃↓ [symbol] Ca²⁺+CO₃²⁻;

the water after having absorbed the CO₂ is brought into contact with a dry decarbonated fluid, which in turn is charged with CO₂;
the dry decarbonated fluid comes from a cryogenic air separation unit;
the dry decarbonated fluid is rich in nitrogen;
the dry decarbonated fluid is at a pressure below that of the cooled air;
the dry decarbonated fluid is at a pressure close to atmospheric pressure;
precipitation of calcium carbonate (CaCO₃) takes place upon direct contact between the water and the air;
the solid calcium carbonate is separated from the water;
a first product is injected into the water, so as to maintain the absorptivity of the water and to modify its pH;
said first product is of basic type, particularly lime, sodium hydroxide or aqueous ammonia;
said product is of acid type, particularly hydrochloric acid;
the dry decarbonated fluid is output by the same air separation unit as that for which the air is intended.

According to other optional aspects, this precooling is characterized in that:
the water used for absorbing the CO₂ is “cold” water since the colder the temperature of the water the larger the quantity of CO₂ that it can absorb;
the pH of the water is above 8;
the absorption also involves one of the calcium chemical equilibria, such as for example: CaCO₃↓ [symbol] Ca²⁺+CO₃²⁻ (5);
the CO₂ is desorbed and removed by bringing the CO₂-laden water into contact with a dry decarbonated fluid, which becomes charged with CO₂, said fluid preferably coming from the cryogenic air separation unit and concomitantly with the cooling of the water by direct heat exchange in a packing tower;
this dry decarbonated fluid is rich in nitrogen;
this dry decarbonated fluid is at a pressure below that of the air, making desorption easier;
the CO₂ is desorbed and at the same time removed in the form of a solid calcium carbonate precipitate involving a calcium chemical equilibrium of the type of (5);
the CO₂ is desorbed and at the same time removed by the combination of contacting the CO₂-laden water with a dry decarbonated fluid, which is then charged with CO₂, and of precipitating solid calcium carbonate;
a product is injected into this precooling system with the aim of maintaining the absorptivity of the water, especially by modifying the pH of the water;
this product for maintaining the absorptivity of the water is of basic type;
this product of basic type is sodium hydroxide NaOH, possibly diluted;
this product of basic type is lime Ca(OH)₂, possibly prediluted in the form of a solution and/or suspension in an aqueous phase;
this product of basic type contains ammonia in NH₃(aq) form (aqueous ammonia) or NH^{4+ form (ammonium salt); and}
this product for maintaining the absorptivity of the water is of acid type if the water becomes too basic.

Another object of the invention is to provide an air pretreatment unit comprising a cooling tower, cooling by direct heat exchange between CO₂-containing air and water, the water used for this heat exchange being basic with a pH>7, characterized in that it includes means for modifying the acid-base equilibrium of the water by adding at least a first basic product to the water upstream of the tower.

Yet another object of the invention is to provide a separation unit for separating gases from air cryogenically, comprising a unit comprising a cooling tower, cooling by direct heat exchange between CO₂-containing air and water, the water used for this heat exchange being basic with a pH>7, characterized in that it includes means for modifying the acid-base equilibrium of the water by adding at least a first basic product to the water upstream of the tower.

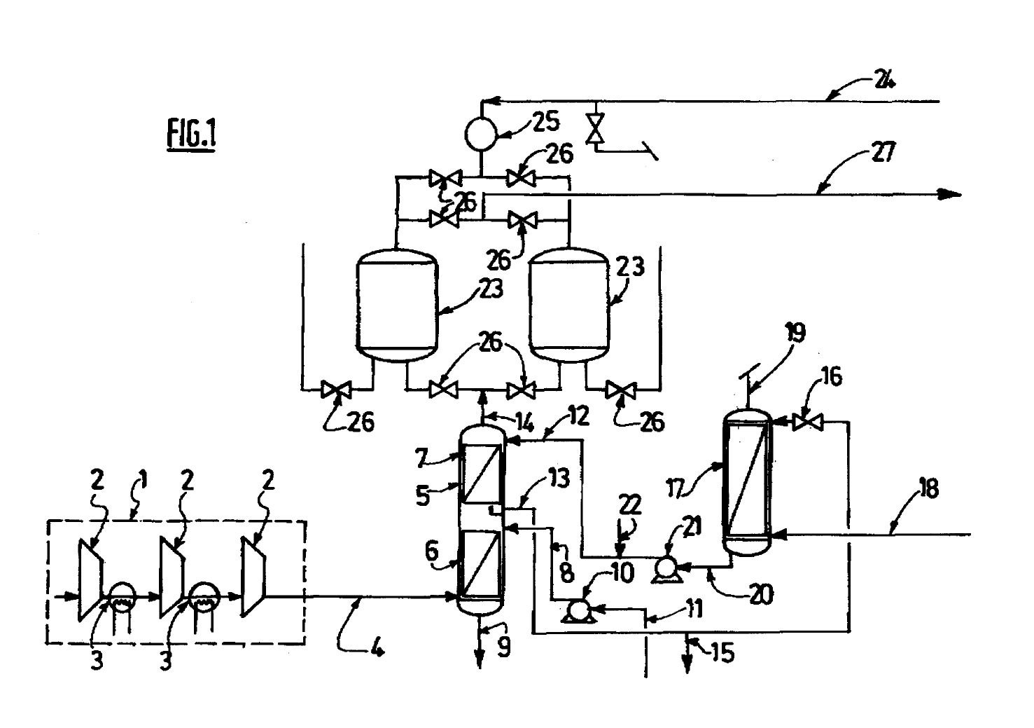

FIG. 1 illustrates a process for the compression, precooling, pretreatment and/or purification of the atmospheric air before cryogenic separation of said air, in particular by cryogenic distillation.

A compressor 1 consisting of several compression stages 2 and of intermediate coolers 3 compresses air, conventionally to a pressure of the order of 6 bar abs (possibly between 3.5 and 35 bar abs) and leaves the last compression stage at a temperature of around 100° C. This air 4 is then introduced into a two-stage packing tower 5 in which it is firstly cooled by direct contact with cooling water 8 to a temperature of around 35° C. in the lower part 6 of this tower 5. This cooling water 8 was compressed beforehand by a pump 10 coming from the cooling water mains 11. It leaves the lower part 6 of the tower 5 at a temperature 45° C. (fluid 9). The air leaves this lower part 6 at a temperature of around 35° C. It will be understood that this cooling means in the lower part of the tower could be replaced with a means described in the introduction of this document.

In the upper part 7 of the tower, the air is cooled by direct contact with “cold” water 12 at a considerably basic pH (between 8 and 12) which absorbs a substantial part of the CO₂ contained in the air. The water 13 leaving the upper part 7 of the tower is at a temperature of around 30° C.: it does not return to the lower part 6 but is entirely or at least predominantly withdrawn at mid-height of the tower 5. The CO₂ content of the air 14 is typically around 10 to 50 ppm and the temperature of this air around 12° C. The CO₂-laden water 13 may possibly be partly purged 15 and then expanded in a valve 16 to a pressure close to atmospheric pressure and introduced into a packing tower 17 in which it is cooled by direct contact with dry decarbonated waste nitrogen 18 output by a cryogenic air separation unit (not illustrated). In the same tower, it at least partly desorbs the CO₂ that it contains. The waste nitrogen 19 coming from the tower 17 is saturated with water and contains the CO₂ desorbed by the water. On leaving the tower, the water 20 is at a temperature of 12° C. The water is compressed in a pump 21 and receives an injection of a first product 22, which may be of basic type such as lime, sodium hydroxide or aqueous ammonia. The injection of this product allows the pH of the water to be modified in such a way that the CO₂ absorption is effective. The product may be injected just before the tower 5, or anywhere in the water cycle 12, 13, 20. The injection of basic product is controlled either by a detector for measuring the pH of the water or by a detector for measuring the CO₂ content of the purified air 14. Likewise, if too much basic product has been sent into the water, it may prove necessary to correct the pH by adding an acid-type second product such as hydrochloric acid, for the purpose of maintaining the capacity of the water to absorb the CO₂. The water is possibly stripped of at least some of its solid suspensions consisting essentially of CaCO₃, upstream or downstream of the point of injection of the product 22. It may be useful to keep part of the solid in suspension in the aqueous phase as precipitation seed.

The air 14 leaving the tower 5 is then dried and fully decarbonated in one of the two adsorbers 23, which typically contains an alumina bed and a molecular sieve bed. At the same time, the other adsorber may be regenerated by another fraction of the dry decarbonated waste nitrogen 24 output by a cryogenic air separation unit, said waste nitrogen possibly being heated in an exchanger 25. The adsorbers are used alternately in adsorption mode and then in regeneration mode, thanks to a system of valves 26. The air 27 leaving an adsorber 23 is dry and decarbonated and can therefore be introduced into a cryogenic air separation unit.

1-15. (canceled)

16: A method for pre-treating air containing CO₂ by direct heat exchange with water so as to cool, in which the acid-base equilibrium of the water used for this heat exchange is modified in such a way that the pH of the water is above 7 and the water absorbs a substantial fraction of the CO₂ contained in the air, characterized in that, after having absorbed the CO₂, the water is brought into contact with a dry decarbonated fluid coming from a cryogenic air separation unit, which is charged in turn with CO₂, and in that the pretreated air is sent to the air separation unit.

17: The method of claim 16, in which the heat exchange by direct contact is carried out with loose or ordered packings.

18: The method of claim 16, in which the absorption of CO₂ in the water involves at least one of the following chemical equilibria:
CO₂(g) [symbol] CO₂(aq) (1) where g and aq indicate a gaseous phase or dissolved phase respectively;
CO₂(aq)+H₂O [symbol] H₂CO₃ (2);
H₂CO₃ [symbol] H⁺+HCO₃⁻ (3);
HCO₃⁻ [symbol] H⁺+CO₃²⁻ (4).

19: The method of claim 16, in which the temperature of the water is substantially below the ambient temperature and/or below the temperature of the cooling water obtained by direct exchange with the atmospheric air.

20: The method of claim 16, in which the acid-base equilibrium of the water is modified in such a way that the pH of the water is above 8.

21: The method of claim 16, in which the water contains calcium and the following equilibrium occurs during direct contact between the water and the air:
CaCO₃↓ [symbol] Ca²⁺+CO₃²⁻.

22: The method of one of claim 16, in which the dry decarbonated fluid is rich in nitrogen.

23: The method of one of claim 16, in which the dry decarbonated fluid is at a pressure below that of the cooled air.

24: The method of one of claim 16, in which the dry decarbonated fluid is at a pressure close to atmospheric pressure.

25: The method of claim 16, in which precipitation of calcium carbonate (CaCO₃) takes place upon direct contact between the water and the air.

26: The method of claim 25, in which the solid calcium carbonate is separated from the water.

27: The method of claim 25, in which a first product is injected into the water, so as to maintain the absorptivity of the water and to modify its pH.

28: The method of claim 27, in which said product is of basic type, particularly lime, sodium hydroxide or aqueous ammonia.

29: The method of claim 27, in which said product is of acid type, particularly hydrochloric acid.

30: A cryogenic air separation unit, comprising an air pretreatment unit comprising a cooling tower, cooling by direct heat exchange between CO₂-containing air and water, the water used for this heat exchange being basic with a pH >7, wherein it includes means for modifying the acid-base equilibrium of the water by adding at least a first basic product to the water upstream of the tower, means for bringing the water that has absorbed the CO₂ into contact with a dry decarbonated fluid coming from a cryogenic air separation unit, and means for sending the pretreated air to the air separation unit.
